(19) United States
(12) Patent Application Publication
(10) Pub. No.: US 2026/0245271 A1
(43) Pub. Date: Aug. 20, 2026

(54) DISPLAY EFFECT PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Hualong NING, Beijing (CN); Wenpeng SUN, Beijing (CN)

(21) Appl. No.: 18/871,388

(22) PCT Filed: Sep. 13, 2023
(86) PCT No.: PCT/CN2023/118433

§ 371 Date: Dec. 3, 2024

(30) Foreign Application Priority Data
Sep. 21, 2022 (CN) 202211153804.6

(51) Int. Cl. G06T 11/60; G06F 3/04845

(52) U.S. Cl. CPC G06T 11/60; G06F 3/04845

(57) ABSTRACT

A display effect processing method and apparatus, an electronic device, and a storage medium. The method includes: determining, in response to an editing operation on a target element, at least one associated element corresponding to the target element and a target display effect of the at least one associated element; and adjusting a current display effect of the at least one associated element in an interactive interface based on the target display effect, such that the target display effect of the at least one associated element is adjusted and displayed according to the editing operation on the target element.

### CROSS-REFERENCE TO RELATED APPLICATION(S)

This application claims priority to Chinese Application No. 202211153804.6 filed in Sep. 21, 2022, the disclosure of which is incorporated herein by reference in its entity.

### FIELD

Embodiments of the present disclosure relate to the field of text editing technologies, and for example, to a display effect processing method and apparatus, an electronic device, and a storage medium.

### BACKGROUND

With the development of network technologies, more and more applications have entered the lives of users. In particular, a series of applications that can post pictures or videos are deeply loved by users.

To improve the diversity of picture/video posting, software developers can develop various text editing templates for text editing of pictures/videos, to improve the display effect of pictures/videos. However, the existing developed text editing templates are not flexible enough in application and cannot meet different text editing requirements.

### SUMMARY

Embodiments of the present disclosure provide a display effect processing method and apparatus, an electronic device, and a storage medium.

According to a first aspect, an embodiment of the present disclosure provides a display effect processing method. The method includes:
determining, in response to an editing operation on a target element, at least one associated element corresponding to the target element and a target display effect of the at least one associated element; and
adjusting, based on the target display effect, a current display effect of the at least one associated element in an interactive interface, such that the target display effect of the at least one associated element is adjusted and displayed based on the editing operation on the target element.

According to a second aspect, an embodiment of the present disclosure further provides a display effect processing apparatus. The apparatus includes:
a display effect determining module configured to determine, in response to an editing operation on a target element, at least one associated element corresponding to the target element and a target display effect of the at least one associated element; and
a display effect display module configured to adjust, based on the target display effect, a current display effect of the at least one associated element in an interactive interface, such that the target display effect of the at least one associated element is adjusted and displayed based on the editing operation on the target element.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the display effect processing method according to any one of the embodiments of the present disclosure.

According to a fourth aspect, an embodiment of the present disclosure further provides a storage medium including computer-executable instructions that, when executed by a computer processor, are used to perform the display effect processing method according to any one of the embodiments of the present disclosure.

### BRIEF DESCRIPTION OF THE DRAWINGS

Throughout the drawings, the same or similar reference numerals denote the same or similar elements. It should be understood that the accompanying drawings are schematic and that parts and elements are not necessarily drawn to scale.

FIG. 1A is a schematic flowchart of a display effect processing method according to an embodiment of the present disclosure;

FIG. 1B is a schematic diagram of a text editing interface according to an embodiment of the present disclosure;

FIG. 1C is a schematic diagram of another text editing interface according to an embodiment of the present disclosure;

FIG. 2A is a schematic flowchart of another display effect processing method according to an embodiment of the present disclosure;

FIG. 2B is a schematic diagram of a constraint relationship between elements represented by a directed acyclic graph according to an embodiment of the present disclosure;

FIG. 2C is a schematic diagram of a type of a constraint logic according to an embodiment of the present disclosure;

FIG. 2D is a schematic diagram of a determination manner of position constraint according to an embodiment of the present disclosure;

FIG. 3 is a schematic flowchart of a text template display effect processing method according to an embodiment of the present disclosure;

FIG. 4 is a block diagram of a structure of a display effect processing apparatus according to an embodiment of the present disclosure; and

FIG. 5 is a schematic diagram of a structure of an electronic device according to an embodiment of the present disclosure.

### DETAILED DESCRIPTION OF EMBODIMENTS

Embodiments of the present disclosure are described below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Additionally, additional steps may be included and/or the execution of the illustrated steps may be omitted in the method implementations. The scope of the present disclosure is not limited in this respect.

The term “include/comprise” used herein and the variations thereof are an open-ended inclusion, that is, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish between different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

Before the present embodiment is described, the application scenarios may be described as examples. The embodiments of the present disclosure may be applied to any interactive interface that requires a display effect. For example, the embodiments may be applied to a case where an effect display may be performed on an image or video corresponding to a photographed user during video shooting, for example, in a short video shooting or editing scenario.

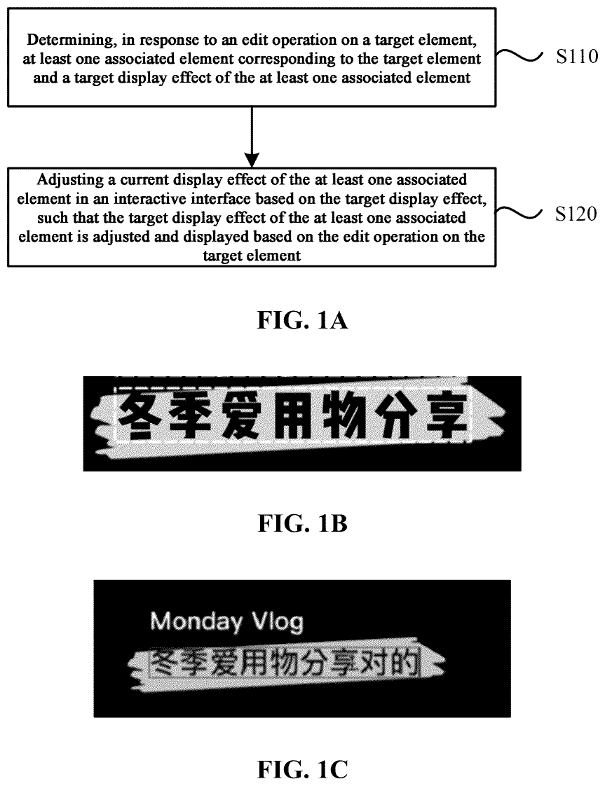

FIG. 1A is a schematic flowchart of a display effect processing method according to an embodiment of the present disclosure. This embodiment is applicable to a case where a display effect is adjusted in any editing scenario supported by the Internet, for example, applicable to a text editing scenario to adjust a text display effect, or applicable to an image editing scenario to adjust an image display effect. The method may be performed by a display effect processing apparatus, which may be implemented in the form of software and/or hardware, and the hardware may be an electronic device, such as a mobile terminal, a personal computer (PC), a server, or other similar devices. Any text editing scenario is usually implemented by a client and a server in coordination. The method provided in this embodiment may be performed by a server, performed by a client, or performed by the client and the server in coordination.

As shown in FIG. 1A, the method in this embodiment includes:

S110: Determine, in response to an editing operation on a target element, at least one associated element corresponding to the target element and a target display effect of the at least one associated element.

The apparatus that performs the display effect processing method provided in the embodiments of the present disclosure may be integrated into an application software that supports a text editing function, and the software may be installed in an electronic device. For example, the electronic device may be a mobile terminal, a PC, or the like. The application software may be a type of software for image/video processing. The application software is not described herein one by one, as long as image/video processing may be implemented. Alternatively, a special application may be developed to implement adding and displaying special effects in the software, or it may be integrated into a corresponding page, and a user may perform special effect adding processing through a page integrated in a PC.

In this embodiment, the target element is an element currently edited by a user, and the associated element may be understood as an element whose display effect is associated with the target element. Taking image editing as an example, the target element may be a currently edited image, and the associated element may be a special effect, padding, background, or the like of the image. Taking text editing as an example, the target element may be a currently edited text or text box, and the associated element may be a background of the text. Text editing may be performed with an image as the background or with a video as the background, or may be performed directly without a background, which is not limited herein. A background for text editing may be obtained in a real-time processing manner, or may be obtained by being retrieved from a stored image or video. In addition, the background image may be a static image or a dynamic image, which is not limited in the embodiments of the present disclosure.

For example, an association relationship between elements may be set in advance based on an association relationship between the elements, an associated element corresponding to the target element is determined through the preset association relationship, and the target display effect of the associated element is determined based on adjustment of the target element, so that the display effect of the element is more flexible.

In an implementation of the present disclosure, the editing operation on the target element includes: detecting a size adjustment operation on the target element; or detecting an editing operation on element content of the target element. Taking text editing as an example, the target element may be text content or a text box. When a font size of the text content or a size adjustment of the text box is detected, it may be determined that the size adjustment operation on the target element is detected. When an editing operation on the text content is detected, for example, the text content is added or deleted, it may be determined that the editing operation on the element content of the target element is detected. Taking image editing as an example, the target element may be an image. When a size adjustment of the image is detected, it may be determined that the size adjustment operation on the target element is detected. When an editing operation on the image is detected, for example, the image is added or deleted, it may be determined that the editing operation on the element content of the target element is detected. When any of the foregoing operations is detected, it may be determined that the editing operation on the target element is detected.

Exemplarily, when a user edits text using a text editing target, the currently edited text content or an associated text box in a text editing template is used as the target element, a background element in the text editing template is used as the associated element, and the target display effect of the background element is determined through the editing of the text content or the text box, so that the background can change with the text, thereby simplifying the use complexity of the text editing template and improving the efficiency of text editing using the text editing template.

In a text editing scenario, a background element may include a plurality of types (such as a background of a highlighted pattern or a background of a filled pattern). During the adjustment of the display effect of the background element, the adjusted and changed display effect may be consistent with the display effect before the adjustment.

S120: Adjust, based on the target display effect, a current display effect of the at least one associated element in the interactive interface, such that the target display effect of the at least one associated element is adjusted and displayed based on the editing operation on the target element.

After the target display effect is determined, the current display effect is adjusted to the target display effect in the interactive interface, such that the display effect of the associated element changes with the adjustment of the target element.

Taking text editing as an example, when text content is added, a coverage area of the text content may exceed a coverage area of the text content before the text is edited. If the coverage area of the background before the adjustment is the same as the coverage area of the text content, after the text content is added, the coverage area of the text content may exceed the coverage area of the background, resulting in a part of the displayed text content without a corresponding background. To improve the display effect, the coverage area of the background may be adjusted to correspond to the coverage area of the text content as the text content is added.

In an implementation of the present disclosure, adjusting the current display effect of the associated element in the interactive interface based on the target display effect includes: determining a target display image based on the target display effect, and displaying the target display image in the interactive interface.

For example, a target display image corresponding to the target display effect may be directly rendered, and the current display effect is directly adjusted to the target display image in the interactive interface. To further determine the effect change process and improve the display effect of the effect change, a plurality of intermediate display effects between the current display effect and the target display effect may be determined as a plurality of display effect change frames, and the plurality of display effect change frames are sequentially displayed in the interactive interface. The current display effect in the interactive interface is adjusted to the target display effect through the plurality of sequentially displayed display effect change frames.

The determining a plurality of intermediate display effects between the current display effect and the target display effect as a plurality of display effect change frames may be: determining the pixel value of a pixel in at least one intermediate display effect based on the difference between pixel values of the pixels in the current display effect and the target display effect, and determining a corresponding display effect change frame based on the pixel value of the pixel.

FIG. 1B is a schematic diagram of a text editing interface according to an embodiment of the present disclosure. FIG. 1B illustratively shows a schematic diagram of a text editing template. The text editing template includes a text box and a background, and a coverage area of the text box matches a coverage area of the background in FIG. 1B. FIG. 1C is a schematic diagram of another text editing interface according to an embodiment of the present disclosure. Compared with FIG. 1B, the content of the text box in FIG. 1C is increased by the text “Yes”, causing an increase in the length of the text box and thus an expansion in the coverage area. To avoid poor text display effect caused by the coverage area of the text box being greater than the coverage area of the background when the text is added in FIG. 1B, in FIG. 1C of this embodiment, the coverage area of the background is adaptively adjusted according to the coverage area of the text box after editing, so that the coverage area of the background still matches the coverage area of the text content after the text content is increased, so that the display effect of the background can change with the editing of the text box, thereby improving the application flexibility of the text editing template.

In the embodiments of the present disclosure, at least one associated element corresponding to a target element and a target display effect of the associated element are determined in response to an editing operation on the target element; and the current display effect of the associated element in the interactive interface is adjusted based on the target display effect, such that the display effect of the associated element and the display effect of the target element are adjusted and displayed in association, so that when the target element is edited and adjusted, the display effect of the associated element can be adaptively adjusted, thereby implementing the adaptive adjustment of the display effect of another element with the editing of the template element, and improving the flexibility of the editing application.

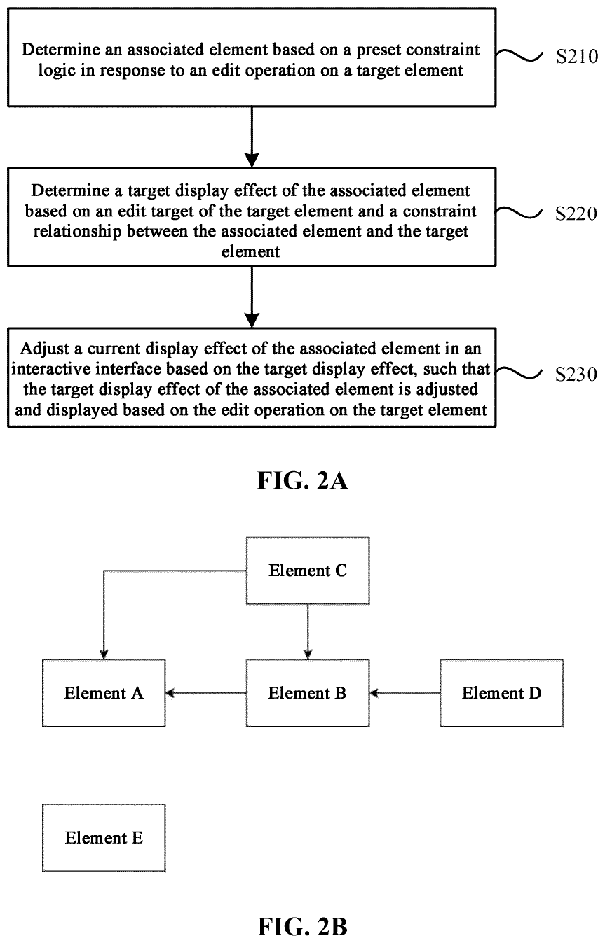

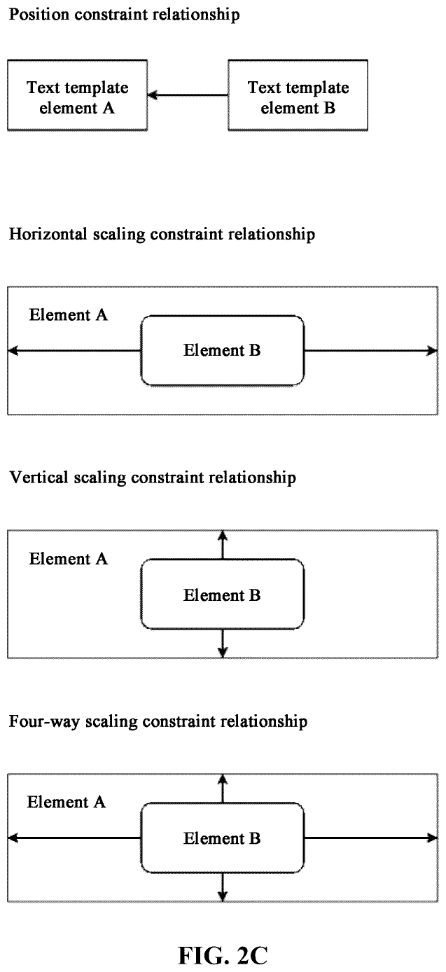

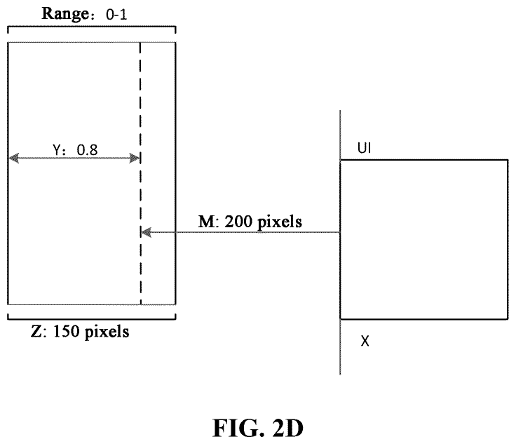

FIG. 2A is a schematic flowchart of another display effect processing method according to an embodiment of the present disclosure. On the basis of the foregoing embodiments, the determination of the target display effect is further refined. The same or corresponding technical terms as those in the foregoing embodiments are not described herein again.

As shown in FIG. 2A, the method includes the following steps:

S210: Determine the associated element according to a preset constraint logic in response to the editing operation on the target element.

In this embodiment, the constraint logic is constructed in advance according to a dependency relationship between the elements, and after the editing operation on the target element is detected, the associated element related to the target element is determined according to the preset constraint logic.

It should be noted that there may be one or more associated elements, and the associated element is an element that has a direct constraint relationship or an indirect constraint relationship with the target element. The direct constraint relationship may be understood as the associated element directly depending on the target element, and the indirect constraint relationship may be understood as the associated element depending on the target element through one or more other associated elements. That is, there is a constraint relationship between the associated element and the target element, and/or the associated elements have the constraint relationship with each other. Exemplarily, assuming that the target element is element A, element B depends on element A, and element C depends on element B, element B and element A have a direct constraint relationship, and element C and element A have an indirect constraint relationship. The constraint relationship may be a position and/or size constraint relationship. Still taking element B depending on element A as an example, element B and element A may have a position constraint relationship, a size constraint relationship, or a position and size constraint relationship. Assuming that element B and element A have a position constraint relationship, it indicates that a position of element B changes with a change in a position of element A. Assuming that element B and element A have a size constraint relationship, it indicates that a size of element B changes with a change in a size of element A. Assuming that element B and element A have a position and size constraint relationship, it indicates that a position and a size of element B change with a change in a position and a size of element A.

In an implementation, an element that has a direct constraint relationship with the target element may be first determined as the associated element, and then an element that has a direct constraint relationship with the associated element is also determined as the associated element with reference to the associated element. The foregoing operation is iteratively performed until there is no element that has a direct constraint relationship with the associated element, and the associated elements determined above are used as the associated elements corresponding to the target element.

For example, the constraint logic may be represented using a directed acyclic graph. In graph theory, if a directed graph cannot return a certain vertex from the same vertex through a plurality of edges, the graph is a directed acyclic graph. FIG. 2B is a schematic diagram of a constraint relationship between elements represented by a directed acyclic graph according to an embodiment of the present disclosure. In the directed acyclic graph, an arrow direction represents a dependency relationship. Assuming that an arrow points from node 1 to node 2, node 1 depends on node 2. As shown in FIG. 2B, both element B and element C depend on element A, that is, have a direct constraint relationship with element A, respectively. Element C also depends on element B, that is, there is a direct constraint relationship between element C and element B. Element D depends on element B, that is, there is a direct constraint relationship between element D and element B. There is an indirect constraint relationship between element D and element A. Element E does not depend on any element. Assuming that element A is the target element, element B, element C, and element D are associated elements.

S220: Determine the target display effect of the associated element based on an editing target of the target element and a constraint relationship between the associated element and the target element.

After the associated element is determined, for each associated element, the target display effect of the associated element is determined based on the editing target of the target element according to the constraint relationship related to the associated element. The editing target is a target of the editing operation. Exemplarily, assuming that the editing operation is to adjust a size of the target element, the editing target is a size of the target element after adjustment. Assuming that the editing operation is to edit element content of the target element, the editing target is the edited element content.

In an implementation, for each associated element, a display constraint relationship between the associated element and the target element may be determined according to the constraint relationship between the associated element and the target element, and the target display effect of the associated element is determined based on the editing target of the target element and the display constraint relationship. Exemplarily, assuming that the target element is element A, the associated elements are element B and element C, element C depends on element B, and element B depends on element A, a display constraint relationship between element C and element A may be determined according to a constraint relationship between element B and element A and a constraint relationship between element C and element B, and a display constraint relationship between element B and element A is determined according to the constraint relationship between element B and element A. Then an element display effect of element C is determined based on the display constraint relationship between element C and element A and the editing target of element A, an element display effect of element B is determined based on the display constraint relationship between element B and element A and the editing target of element A, and finally the target display effect is determined based on the element display effects of the elements. By directly determining the display constraint relationship between the associated element and the target element, it is ensured that the element display effect of each associated element is not affected by the element display effect of another associated element, and parallel processing of the target display effect of each associated element can be implemented, thereby improving the efficiency and accuracy of the target display effect of the associated element.

In another implementation, the target display effect of each associated element may also be determined sequentially according to the constraint relationship between the associated elements. Based on this, there are a plurality of associated elements, and the determining the target display effect of the associated element based on the editing target of the target element and the constraint relationship between the associated element and the target element includes: determining an element display effect of each associated element sequentially based on the editing target of the target element according to the constraint relationship between the associated elements and the constraint relationship between the associated element and the target element; and combining the element display effects of the associated elements to obtain the target display effect. That is, a determination sequence of the display effect may be determined according to the constraint relationship between the elements, and the element display effect of each associated element is determined sequentially based on the determination sequence of the display effect. For example, the determination may be started from an associated element that has a direct constraint relationship with the target element, and the element display effect of each associated element is determined sequentially according to the constraint relationship, to finally determine the target display effect.

For example, the determining an element display effect of each associated element sequentially based on the editing target of the target element according to the constraint relationship between the associated elements and the constraint relationship between the associated element and the target element includes: determining an associated element as a reference adjustment element based on the constraint relationship between the associated elements and the constraint relationship between the associated element and the target element; determining an element adjustment sequence based on the constraint relationship between the associated elements; and determining the element display effect of each associated element sequentially based on the editing target of the target element and the element adjustment sequence with reference to the reference adjustment element. For example, an associated element that directly depends on the target element may be used as the reference adjustment element, or an associated element that does not depend on the target element may be used as the reference adjustment element, and the element adjustment sequence is determined according to the constraint relationship between the elements, to determine the element display effect of each associated element sequentially. Assuming that the target element is element A, and the associated elements are element B, element C, and element D, element D depends on element C, element C depends on element B, and element B depends on element A, element D or element B may be used as the reference adjustment element. When element D is the reference adjustment element, an order of element D, element C, and element B may be used as the element adjustment sequence; and when element B is the reference adjustment element, an order of element B, element C, and element D may be used as the element adjustment sequence. Sequentially determining the element display effect of each element based on the dependency relationship between the elements simplifies the relationship determination operation compared with separately determining the display effect of each element.

In an implementation, the constraint logic is represented by a directed acyclic graph, any node in the directed acyclic graph is the target element or the associated element, and the determining an associated element as a reference adjustment element based on the constraint relationship between the associated elements and the constraint relationship between the associated element and the target element includes: determining an in-degree parameter of each node in the directed acyclic graph, and using an element corresponding to a node with an in-degree of zero as the reference adjustment element. In a directed acyclic graph, a number of edges with the node as a head is referred to as an in-degree of the vertex, and a number of edges with the node as a tail is referred to as an out-degree of the vertex. When the in-degree of the node is 0, it indicates that no node depends on the node. To reduce the number of adjustments and avoid adjusting the same associated element multiple times, the element corresponding to the node may be used as the reference adjustment element. Based on this, in a process of determining the element display effect of the associated element, the nodes may be divided into two groups: an unadjusted group and an adjusted group. Then the nodes are sorted based on the in-degree of the nodes, and a node with in-degree and out-degree of zero is divided into the adjusted group. After the other nodes are adjusted, an out-degree value is adjusted and the node is divided into the adjusted group until there is no node whose out-degree is 0, and traversal stops.

Based on the reference adjustment element, the element display effect of each associated element is determined sequentially based on the element adjustment sequence, including: for any associated element to be adjusted, determining a dependent associated element of the associated element to be adjusted according to the constraint logic; and determining the element display effect of the associated element to be adjusted based on an element display effect of the dependent associated element. The associated element currently traversed in the sequence may be used as the associated element to be adjusted. Assuming that the constraint relationship between the associated elements is shown in FIG. 2B, and the associated element to be adjusted is element C, it can be learned from FIG. 2B that element C depends on element A and element B. Therefore, element A and element B are used as the dependent associated elements, and the element display effect of element C is determined based on the element display effects of element A and element B.

In an implementation, the element display effect is a size of the element, and the determining the element display effect of the associated element to be adjusted based on an element display effect of the dependent associated element includes: determining an associated constraint size based on an element size of the dependent associated element; determining a fixed constraint size between the dependent associated element and the associated element to be adjusted; and determining a size of the associated element to be adjusted based on the associated constraint size and the fixed constraint size. Taking text editing as an example, to enable a background of the text to correspond to text content during text editing, the size of the background needs to be adjusted to correspond to the size of the text content. Based on this, the display effect of the background is implemented by adjusting the size of the background. To enable a position relationship and a size relationship between the adjusted elements to correspond to those before the adjustment, the size of the element to be adjusted may be determined by combining a fixed constraint and a floating constraint. Taking element B as the associated element to be adjusted and element A as the dependent associated element as an example, a fixed constraint size between element B and element A (for example, a center position distance, a distance between corresponding sides, or the like) may be preset. After the size of element A is adjusted, an associated constraint size of element A is determined based on the adjusted size of element A, and the size of element B is determined based on the associated constraint size and the fixed constraint size.

It should be noted that a determination manner of the fixed constraint size and the associated constraint size is associated with a type of the constraint logic between the elements. FIG. 2C is a schematic diagram of a type of a constraint logic according to an embodiment of the present disclosure. In FIG. 2C, the type of the constraint logic between the elements is schematically described by taking text editing as an example. In FIG. 2C, element A and element B in a text template may be different types of constraint logics, such as a position constraint relationship, a horizontal scaling constraint relationship, a vertical scaling constraint relationship, and a four-side scaling constraint relationship. The position constraint relationship may be that element B changes as a position (movement) of element A changes. The horizontal scaling constraint relationship may be that a horizontal size of element B changes as a horizontal size of element A changes. The vertical scaling constraint relationship may be that a vertical size of element B changes as a vertical size of element A changes. The four-side scaling constraint relationship may be that an overall size of element B changes as an overall size of element A changes.

When the size of the associated element to be adjusted is determined, the size of the associated element to be adjusted may be determined in a horizontal direction and/or a vertical direction based on different constraint logics, and the size in each direction may be determined in the foregoing manner. For example, assuming that the constraint between the elements is a position relationship constraint, coordinates of the associated element to be adjusted may be determined based on a coordinate (for example, a center point coordinate) direction of the dependent associated element; assuming that the constraint between the elements is a horizontal scaling constraint, a horizontal size of the associated element to be adjusted may be determined based on a horizontal size of the dependent associated element; assuming that the constraint between the elements is a vertical scaling constraint, a vertical size of the associated element to be adjusted may be determined based on a vertical size of the dependent associated element; and assuming that the constraint between the elements is a four-side scaling constraint, a horizontal size of the associated element to be adjusted may be determined based on a horizontal size of the dependent associated element, and a vertical size of the associated element to be adjusted may be determined based on a vertical size of the dependent associated element.

Taking the position constraint as an example, an update of the size of the associated element is exemplarily described. FIG. 2D is a schematic diagram of a determination manner of position constraint according to an embodiment of the present disclosure. In FIG. 2D, the left side represents the dependent associated element, and the right side represents the associated element to be adjusted.

In FIG. 2D, UI represents a user interface (UI).

As shown in FIG. 2D, the position of the associated element to be adjusted can be determined by X=Y*Z+M, where M is the fixed constraint size between the associated element to be adjusted and the dependent associated element, representing a fixed distance between a left side of the associated element to be adjusted and a right side of the dependent associated element, Y is a proportion of the dependent associated element after adjustment, and Z is a width of the dependent associated element.

It should be noted that when there are a plurality of dependent associated elements corresponding to the associated element to be adjusted, the element display effect of the associated element to be adjusted may be directly determined based on the plurality of dependent associated elements, or the element display effect of the associated element to be adjusted may be determined based on each dependent element relationship.

S230: Adjust the current display effect of the associated element in the interactive interface based on the target display effect, such that the target display effect of the associated element is adjusted and displayed based on the editing operation on the target element.

In this embodiment, the associated element is determined based on the preset constraint logic, and the target display effect of the associated element is determined based on the editing target of the target element and the constraint relationship between the associated element and the target element, ensuring the determination of the target display effect of the associated element is more accurate, thereby making the associated display effect between the associated element and the target element better.

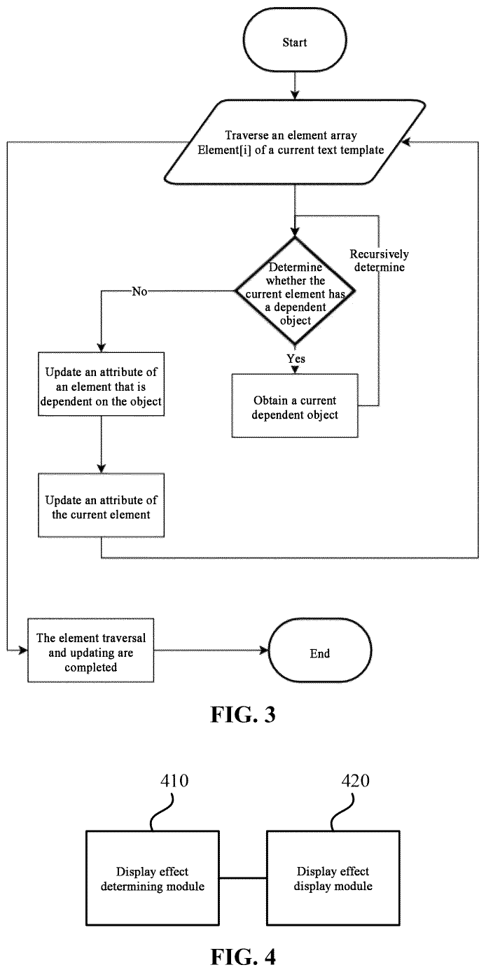

FIG. 3 is a schematic flowchart of a text template display effect processing method according to an embodiment of the present disclosure. FIG. 3 provides a preferred example of adjusting a text display effect by using, as an example, text in a text editing scenario as a target element.

In this example, a dependency relationship is constructed in advance according to a relationship between the elements, and may be displayed in a directed acyclic graph manner. Information of a dependent object is stored for each element, so that when the dependent object changes, the element can change accordingly.

As shown in FIG. 3, during text editing, elements of a current text template are traversed to determine whether a currently traversed element has a dependent object, and if there is a dependent object, the dependent object is used as a new traversed element for determination until there is no dependent object in the traversed element. An element attribute of the currently traversed element is updated according to a text editing target, and then an element attribute of the element that is dependent on the element is further updated until the traversal and updating of all elements are completed, to complete the updating of attributes of all associated elements.

During the element attribute updating, as in the foregoing embodiments, the element attribute updating may be implemented in a horizontal direction and/or a vertical direction.

Exemplarily, updating an element attribute in a horizontal direction may be as follows: (1) a dependency graph is established for a constraint node, and the constraint node is divided into two groups: unconstrained and constrained. A control with a fixed size needs to establish a special constraint on the left and right sides, and only the in-degree is counted for a size constraint, and the out-degree is not counted. (2) Nodes are sorted by in-degree, all nodes with in-degree and out-degree of zero (independent nodes) are taken out and placed in the constrained group. A dependent object of a node with the out-degree of 0 is traversed, and placed in the constrained group, and an out-degree of a target node is decreased by 1. A loop is performed until the unconstrained group is empty. If no node whose out-degree is 0 is found, it indicates that there is a dependency loop, and traversal stops.

Updating an element attribute in a vertical direction may be the same as updating an element attribute in a horizontal direction. In addition, if there is an element with an aspect ratio kept, updating an attribute in a vertical direction may damage a dependency in a horizontal direction, and it is necessary to recalculate once.

The text template display effect processing method provided in this embodiment may be implemented by a text template editing system. The constraint logic between different elements is used to replace the original framework logic of the text template editing system implemented by using a rendering engine entity component system (ECS) architecture in the text template, allowing for more flexible implementation of the logic design between elements. An overall framework of a design solution may include a service interface call layer, a software development kit (SDK) script layer (a scene service logic layer), and an SDK basic function architecture layer. The SDK basic function architecture layer further includes a JS script framework layer and an SDK rendering engine. The JS script layer can implement a framework of creating and deleting each basic element, dynamic expansion of the element, etc. The SDK script layer can set all service logics, such as element constraint updating, position change, and the like. It should be noted that the constraint logic and the framework logic such as element creation attribute updating are all implemented by using a script solution. For a user who wants to expand more design template functions, the script can be directly changed, and a script with a new function is dynamically delivered to a client through a background, to achieve the purpose of hot update.

In this embodiment, the constraint relationship corresponding to the different elements is established, and when it is detected that the current element changes, another element that depends on the current element changes accordingly. For example, when text is continuously entered, a background image behind the text changes with the text, which can better meet the diversified design requirements of the user for the text template and make the application of the text template more flexible.

FIG. 4 is a block diagram of a structure of a display effect processing apparatus according to an embodiment of the present disclosure. The apparatus can perform the display effect processing method provided in any embodiment of the present disclosure, and has corresponding functional modules and beneficial effects for performing the method. As shown in FIG. 4, the apparatus includes: a display effect determining module 410 and a display effect display module 420.

The display effect determining module 410 is configured to determine, in response to an editing operation on a target element, at least one associated element corresponding to the target element and a target display effect of the associated element; and the display effect display module 420 is configured to adjust a current display effect of the associated element in an interactive interface based on the target display effect, such that the target display effect of the associated element is adjusted and displayed based on the editing operation on the target element.

Based on the foregoing embodiments, the editing operation on the target element includes: detecting a size adjustment operation on the target element; or detecting an editing operation on element content of the target element.

Based on the foregoing embodiments, adjusting the current display effect of the associated element in the interactive interface based on the target display effect includes:
determining a target display image based on the target display effect, and displaying the target display image in the interactive interface.

Based on the foregoing embodiments, determining at least one associated element corresponding to the target element and a target display effect of the associated element includes:
determining the associated element based on a preset constraint logic, where the associated element has a constraint relationship with the target element, and/or the associated elements have a constraint relationship with each other, and the constraint relationship is at least one of position or size constraint relationship; and determining the target display effect of the associated element based on an editing target of the target element and a constraint relationship between the associated element and the target element, where the editing target is a target of the editing operation.

Based on the foregoing embodiments, there are a plurality of associated elements, and the determining the target display effect of the associated element based on the editing target of the target element and the constraint relationship between the associated element and the target element includes:
determining an element display effect of each associated element sequentially based on the editing target of the target element according to the constraint relationship between the associated elements and the constraint relationship between the associated element and the target element; and
combining the element display effects of the associated elements to obtain the target display effect.

Based on the foregoing embodiments, the determining an element display effect of each associated element sequentially based on the editing target of the target element according to the constraint relationship between the associated elements and the constraint relationship between the associated element and the target element includes:
determining an associated element as a reference adjustment element based on the constraint relationship between the associated elements and the constraint relationship between the associated element and the target element;
determining an element adjustment sequence based on the constraint relationship between the associated elements; and
determining the element display effect of each associated element sequentially based on the editing target of the target element and the element adjustment sequence with reference to the reference adjustment element.

Based on the foregoing embodiments, the determining the element display effect of each associated element sequentially based on the element adjustment sequence with reference to the reference adjustment element includes:
for any associated element to be adjusted, determining a dependent associated element of the associated element to be adjusted according to the constraint logic; and
determining the element display effect of the associated element to be adjusted based on an element display effect of the dependent associated element.

Based on the foregoing embodiments, the element display effect is a size of the element, and the determining the element display effect of the associated element to be adjusted based on an element display effect of the dependent associated element includes:
determining an associated constraint size based on an element size of the dependent associated element;
determining a fixed constraint size between the dependent associated element and the associated element to be adjusted; and
determining a size of the associated element to be adjusted based on the associated constraint size and the fixed constraint size.

Based on the foregoing embodiments, the constraint logic is represented by a directed acyclic graph, any node in the directed acyclic graph is the target element or the associated element, and the determining an associated element as a reference adjustment element based on the constraint relationship between the associated elements and the constraint relationship between the associated element and the target element includes:
determining an in-degree parameter of each node in the directed acyclic graph, and using an element corresponding to a node with an in-degree parameter of zero as the reference adjustment element.

Based on the foregoing embodiments, the target element is a text box, and the associated element is a background of the text box.

In this embodiment, at least one associated element corresponding to a target element and a target display effect of the associated element are determined in response to an editing operation on the target element; and the current display effect of the associated element in the interactive interface is adjusted based on the target display effect, such that the target display effect of the associated element is adjusted and displayed based on the editing operation on the target element, so that when the target element is edited and adjusted, the display effect of the associated element can be adaptively adjusted, thereby implementing the adaptive adjustment of the display effect of the text with text editing, and improving the application flexibility of the text editing template.

The display effect processing apparatus provided in the embodiments of the present disclosure can perform the display effect processing method provided in any embodiment of the present disclosure, and has corresponding functional modules and beneficial effects for performing the method.

It should be noted that the foregoing units and modules included in the apparatus are divided according to functional logic, but are not limited to the foregoing division, as long as corresponding functions can be implemented. In addition, names of the functional units are only used to distinguish each other, and are not used to limit the scope of protection of the embodiments of the present disclosure.

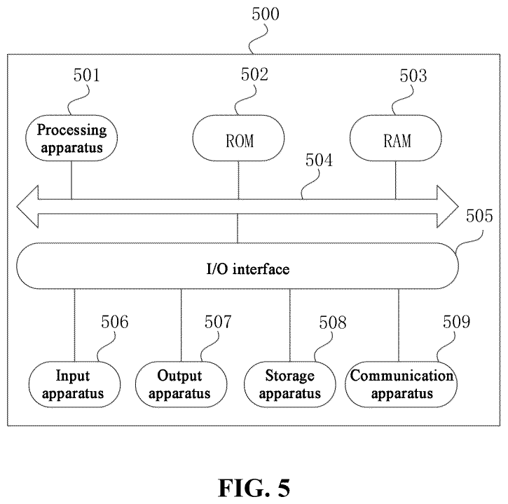

FIG. 5 is a schematic diagram of a structure of an electronic device according to an embodiment of the present disclosure. Reference is made to FIG. 5 below, which is a schematic diagram of a structure of an electronic device (for example, a terminal device or a server in FIG. 5) 500 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), and a portable media player (PMP), and fixed terminals such as a digital television (TV) and a desktop computer. The electronic device shown in FIG. 5 is merely an example, and shall not impose any limitation on the function and scope of use of the embodiments of the present disclosure.

As shown in FIG. 5, the electronic device 500 may include a processing apparatus (for example, a central processor, a graphics processor, etc.) 501 that can execute a variety of appropriate actions and processes in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementation of the present disclosure are used for illustrative purposes only, and are not used to limit the scope of these messages or information.

The electronic device provided in this embodiment of the present disclosure and the display effect processing method provided in the above embodiment belong to the same inventive concept. For technical details not described in detail in this embodiment, reference may be made to the above embodiment, and this embodiment and the above embodiment have the same beneficial effects.

An embodiment of the present disclosure provides a computer storage medium having stored thereon a computer program that, when executed by a processor, causes the display effect processing method provided in the above embodiment to be implemented.

It should be noted that the computer-readable medium described above in the present disclosure may be a computer-readable signal medium, a computer-readable storage medium, or any combination thereof. The computer-readable storage medium may be, for example but not limited to, electrical, magnetic, optical, electromagnetic, infrared, or semiconductor systems, apparatuses, or devices, or any combination of both. Examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, the client and the server may communicate using any currently known or future-developed network protocol such as a hypertext transfer protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
determine, in response to an editing operation on a target element, at least one associated element corresponding to the target element and a target display effect of the associated element; and
adjust a current display effect of the associated element in an interactive interface based on the target display effect, such that the target display effect of the associated element is adjusted and displayed based on the editing operation on the target element.

The storage medium may be a non-transitory storage medium.

The computer program code for performing the operations of the present disclosure may be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of a remote computer, the remote computer may be connected to a computer of a user through any kind of network, including a local area network (LAN) or a wide area network (WAN), or may be connected to an external computer (for example, connected through the Internet using an Internet service provider).

The flowcharts and block diagrams in the accompanying drawings illustrate possible system architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented by software, or may be implemented by hardware. The name of a unit does not constitute a limitation on the unit itself in some cases. For example, a first obtaining unit may also be described as a “unit that obtains at least two Internet protocol addresses”.

The functions described herein above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. Examples of the machine-readable storage medium may include an electrical connection based on one or more wires, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination thereof.

According to one or more embodiments of the present disclosure, [Example 1] provides a display effect processing method, where the method includes:
determining, in response to an editing operation on a target element, at least one associated element corresponding to the target element and a target display effect of the associated element; and
adjusting a current display effect of the associated element in an interactive interface based on the target display effect, such that the target display effect of the associated element is adjusted and displayed based on the editing operation on the target element.

According to one or more embodiments of the present disclosure, [Example 2] provides a display effect processing method,
the editing operation on the target element includes:
detecting a size adjustment operation on the target element; or
detecting an editing operation on element content of the target element.

According to one or more embodiments of the present disclosure, [Example 3] provides a display effect processing method, further including:
the adjusting the current display effect of the associated element in the interactive interface based on the target display effect includes:
determining a target display image based on the target display effect, and displaying the target display image in the interactive interface.

According to one or more embodiments of the present disclosure, [Example 4] provides a display effect processing method, further including:
the determining at least one associated element corresponding to the target element and a target display effect of the associated element includes:
determining the associated element based on a preset constraint logic, where the associated element has a constraint relationship with the target element, and/or the associated elements have a constraint relationship with each other, and the constraint relationship is at least one of position or size constraint relationship; and
determining the target display effect of the associated element based on an editing target of the target element and a constraint relationship between the associated element and the target element, where the editing target is a target of the editing operation.

According to one or more embodiments of the present disclosure, [Example 5] provides a display effect processing method,
there are a plurality of associated elements, and the determining the target display effect of the associated element based on the editing target of the target element and the constraint relationship between the associated element and the target element includes:
determining an element display effect of each associated element sequentially based on the editing target of the target element according to the constraint relationship between the associated elements and the constraint relationship between the associated element and the target element; and
combining the element display effects of the associated elements to obtain the target display effect.

According to one or more embodiments of the present disclosure, [Example 6] provides a display effect processing method, further including:
the determining an element display effect of each associated element sequentially based on the editing target of the target element according to the constraint relationship between the associated elements and the constraint relationship between the associated element and the target element includes:
determining an associated element as a reference adjustment element based on the constraint relationship between the associated elements and the constraint relationship between the associated element and the target element;
determining an element adjustment sequence based on the constraint relationship between the associated elements; and
determining the element display effect of each associated element sequentially based on the editing target of the target element and the element adjustment sequence with reference to the reference adjustment element.

According to one or more embodiments of the present disclosure, [Example 7] provides a display effect processing method, further including:
the determining the element display effect of each associated element sequentially based on the element adjustment sequence with reference to the reference adjustment element includes:
for any associated element to be adjusted, determining a dependent associated element of the associated element to be adjusted according to the constraint logic; and
determining the element display effect of the associated element to be adjusted based on an element display effect of the dependent associated element.

According to one or more embodiments of the present disclosure, [Example 8] provides a display effect processing method,
the element display effect is a size of the element, and the determining the element display effect of the associated element to be adjusted based on an element display effect of the dependent associated element includes:
determining an associated constraint size based on an element size of the dependent associated element;
determining a fixed constraint size between the dependent associated element and the associated element to be adjusted; and
determining a size of the associated element to be adjusted based on the associated constraint size and the fixed constraint size.

According to one or more embodiments of the present disclosure, [Example 9] provides a display effect processing method, where the constraint logic is represented by a directed acyclic graph, any node in the directed acyclic graph is the target element or the associated element, and the determining an associated element as a reference adjustment element based on the constraint relationship between the associated elements and the constraint relationship between the associated element and the target element includes:
determining an in-degree parameter of each node in the directed acyclic graph, and using an element corresponding to a node with an in-degree parameter of zero as the reference adjustment element.

According to one or more embodiments of the present disclosure, [Example 10] provides a display effect processing method, where the target element is a text box, and the associated element is a background of the text box.

A person skilled in the art should understand that the scope of disclosure involved in the present disclosure is not limited to the embodiments formed by a specific combination of the foregoing technical features, and should also cover other embodiments formed by any combination of the foregoing technical features or equivalent features thereof without departing from the foregoing concept of disclosure. For example, an embodiment formed by replacing the foregoing features with technical features with similar functions disclosed in the present disclosure (but not limited thereto).

In addition, although the operations are depicted in a specific order, it should not be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. Instead, the specific features and actions described above are merely exemplary forms of implementing the claims.

1. A display effect processing method, comprising:
determining, in response to an editing operation on a target element, at least one associated element corresponding to the target element and a target display effect of the at least one associated element; and
adjusting a current display effect of the at least one associated element in an interactive interface based on the target display effect, such that the target display effect of the at least one associated element is adjusted and displayed based on the editing operation on the target element.

2. The method according to claim 1, wherein the editing operation on the target element comprises:
detecting a size adjustment operation on the target element; or
detecting an editing operation on element content of the target element.

3. The method according to claim 1, wherein adjusting the current display effect of the at least one associated element in the interactive interface based on the target display effect comprises:
determining a target display image based on the target display effect, and displaying the target display image in the interactive interface.

4. The method according to claim 1, wherein determining the at least one associated element corresponding to the target element and the target display effect of the at least one associated element comprises:
determining the at least one associated element according to a preset constraint logic, wherein the at least one associated element has a constraint relationship with the target element, and/or the at least one associated element has a constraint relationship with each other, and the constraint relationship is at least one of position or size constraint relationship; and
determining the target display effect of the at least one associated element based on an editing target of the target element and the constraint relationship between the at least one associated element and the target element, wherein the editing target is a target of the editing operation.

5. The method according to claim 4, wherein the at least one associated element comprises a plurality of associated elements, and determining the target display effect of the at least one associated element based on the editing target of the target element and the constraint relationship between the at least one associated element and the target element comprises:
based on the editing target of the target element, determining an element display effect of each of the associated elements sequentially according to the constraint relationship between the at least one associated element and the constraint relationship between the at least one associated element and the target element; and
obtaining the target display effect by combining the element display effects of each of the associated elements.

6. The method according to claim 5, wherein based on the editing target of the target element, determining an element display effect of each of the associated elements sequentially according to the constraint relationship between the at least one associated element and the constraint relationship between the at least one associated element and the target element comprises:
determining an associated element as a reference adjustment element based on the constraint relationship between the at least one associated element and the constraint relationship between the at least one associated element and the target element;
determining an element adjustment sequence based on the constraint relationship between the at least one associated element; and
determining the element display effect of each of the associated elements sequentially based on the editing target of the target element and the element adjustment sequence with reference to the reference adjustment element.

7. The method according to claim 6, wherein determining the element display effect of each of associated elements sequentially based on the editing target of the target element and the element adjustment sequence with reference to the reference adjustment element comprises:
for any associated element to be adjusted, determining a dependent associated element of the associated element to be adjusted according to the constraint logic; and
determining an element display effect of the associated element to be adjusted based on the element display effect of the dependent associated element.

8. The method according to claim 7, wherein the element display effect is a size of the element, and determining the element display effect of the associated element to be adjusted based on the element display effect of the dependent associated element comprises:
determining an associated constraint size based on an element size of the dependent associated element;
determining a fixed constraint size between the dependent associated element and the associated element to be adjusted; and
determining a size of the associated element to be adjusted based on the associated constraint size and the fixed constraint size.

9. The method according to claim 6, wherein the constraint logic is represented by a directed acyclic graph, any node in the directed acyclic graph is the target element or the associated element, and determining the associated element as the reference adjustment element based on the constraint relationship between the at least one associated element and the constraint relationship between the at least one associated element and the target element comprises:
determining an in-degree parameter of each node in the directed acyclic graph, and determining an element corresponding to a node with an in-degree parameter of zero as the reference adjustment element.

10. The method according to claim wherein the target element is a text box, and the at least one associated element is a background of the text box.

11. (canceled)

12. An electronic device, comprising:
one or more processors; and
a storage apparatus configured to store one or more programs which, when executed by the one or more processors, causing the one or more processors to:
determine, in response to an editing operation on a target element, at least one associated element corresponding to the target element and a target display effect of the at least one associated element; and
adjust a current display effect of the at least one associated element in an interactive interface based on the target display effect, such that the target display effect of the at least one associated element is adjusted and displayed based on the editing operation on the target element.

13. A non-transitory storage medium containing computer-executable instructions which, when executed by a computer processor, causing the computer processor:
determine, in response to an editing operation on a target element, at least one associated element corresponding to the target element and a target display effect of the at least one associated element; and
adjust a current display effect of the at least one associated element in an interactive interface based on the target display effect, such that the target display effect of the at least one associated element is adjusted and displayed based on the editing operation on the target element.

14. The electronic device according to claim 12, wherein the editing operation on the target element comprises:
detecting a size adjustment operation on the target element; or
detecting an editing operation on element content of the target element.

15. The electronic device according to claim 12, wherein the one or more programs causing the one or more processors to adjust the current display effect of the at least one associated element in the interactive interface based on the target display effect further cause the one or more processors to:
determine a target display image based on the target display effect, and display the target display image in the interactive interface.

16. The electronic device according to claim 12, wherein the one or more programs causing the one or more processors to determine the at least one associated element corresponding to the target element and the target display effect of the at least one associated element further cause the one or more processors to:
determine the at least one associated element according to a preset constraint logic, wherein the at least one associated element has a constraint relationship with the target element, and/or the at least one associated element has a constraint relationship with each other, and the constraint relationship is at least one of position or size constraint relationship; and
determine the target display effect of the at least one associated element based on an editing target of the target element and the constraint relationship between the at least one associated element and the target element, wherein the editing target is a target of the editing operation.

17. The electronic device according to claim 16, wherein the at least one associated element comprises a plurality of associated elements, and the one or more programs causing the one or more processors to determine the target display effect of the at least one associated element based on the editing target of the target element and the constraint relationship between the at least one associated element and the target element further cause the one or more processors to:
based on the editing target of the target element, determine an element display effect of each of the associated elements sequentially according to the constraint relationship between the at least one associated element and the constraint relationship between the at least one associated element and the target element; and
obtain the target display effect by combining the element display effects of each of the associated elements.

18. The electronic device according to claim 17, wherein the one or more programs causing the one or more processors to, based on the editing target of the target element, determine an element display effect of each of the associated elements sequentially according to the constraint relationship between the at least one associated element and the constraint relationship between the at least one associated element and the target element further cause the one or more processors to:
determine an associated element as a reference adjustment element based on the constraint relationship between the at least one associated element and the constraint relationship between the at least one associated element and the target element;
determine an element adjustment sequence based on the constraint relationship between the at least one associated element; and
determine the element display effect of each of the associated elements sequentially based on the editing target of the target element and the element adjustment sequence with reference to the reference adjustment element.

19. The electronic device according to claim 18, wherein the one or more programs causing the one or more processors to determine the element display effect of each of associated elements sequentially based on the editing target of the target element and the element adjustment sequence with reference to the reference adjustment element further cause the one or more processors to:
for any associated element to be adjusted, determine a dependent associated element of the associated element to be adjusted according to the constraint logic; and
determine an element display effect of the associated element to be adjusted based on the element display effect of the dependent associated element.

20. The electronic device according to claim 19, wherein the element display effect is a size of the element, and the one or more programs causing the one or more processors to determine the element display effect of the associated element to be adjusted based on the element display effect of the dependent associated element further cause the one or more processors to:
determine an associated constraint size based on an element size of the dependent associated element;
determine a fixed constraint size between the dependent associated element and the associated element to be adjusted; and
determine a size of the associated element to be adjusted based on the associated constraint size and the fixed constraint size.

21. The electronic device according to claim 18, wherein the constraint logic is represented by a directed acyclic graph, any node in the directed acyclic graph is the target element or the associated element, and the one or more programs causing the one or more processors to determine the associated element as the reference adjustment element based on the constraint relationship between the at least one associated element and the constraint relationship between the at least one associated element and the target element further cause the one or more processors to:
determine an in-degree parameter of each node in the directed acyclic graph, and determine an element corresponding to a node with an in-degree parameter of zero as the reference adjustment element.
